(19) United States
(12) Patent Application Publication
(10) Pub. No.: US 2008/0175956 A1
(43) Pub. Date: Jul. 24, 2008

(54) METHOD FOR PREPARING COLOR STABILIZED WHOLE WHEAT PASTA

(76) Inventor: Dhyaneshwar Bhujanga Rao Chawan, Liverpool, NY (US)

Correspondence Address: Dennis H. Rainear, 13400 College Valley Lane, Richmond, VA, 23233, US

(21) Appl. No.: 11/626,034

(22) Filed: Jan. 23, 2007

(51) Int. Cl. A23L 1/277; A21D 10/02; A23L 1/16; A23L 1/30; A23L 1/22; A23L 1/27

(52) U.S. Cl. 426/72; 426/128; 426/250; 426/254; 426/259; 426/260; 426/262; 426/557; 426/74; 426/93

(57) ABSTRACT

There is disclosed a method for preparing whole grain pasta products with improved (lighter) color or traditional pasta color by utilizing a reducing agent in the milling step or pasta manufacturing step from ‘dry’-milled whole durum wheat. Also provided is a whole grain pasta product with pale, amber yellow, or golden color. In addition, there is provided a method to control the texture of pasta without the use of eggs by including propylene glycol alginate (PGA), or one or more pharmaceutically acceptable salts thereof, instead.

### FIELD OF THE DISCLOSURE

The present disclosure relates to a process for color stabilization in pasta. More specifically, there is presented a method for reducing or preventing the dark coloration that frequently appears in pasta derived from milling whole grains, such as durum wheat or (white) hard spring wheat. By the present disclosure the color of whole wheat pasta is stabilized against degradation.

### BACKGROUND OF THE DISCLOSURE

The use of whole grains in pasta is known. However, generally the use of the whole grain in preparing flour for pasta products results in a dark coloration in the resulting product. For some consumers, for example, children, such coloration are not recognized as reflecting whole grain nutrition, enhanced dietary value and beneficial health attributes. Rather, there is a desire among some consumers for a lighter coloration in pasta derived from whole grains. In addition, manufacturers of pasta products often desire achieving the ability to label their pasta products as “whole grain.” The use of white wheat or so-called spring wheat rather than durum wheat will produce a lighter colored pasta product, but such a product has a color, texture, and flavor that are not acceptable to both the product manufacturer and the consumer.

U.S. Pat. No. 4,956,190 relates to improvements in flour from durum wheat, and pasta produced therefrom, wherein the flour is produced by milling of grains and legumes previously tempered in the presence of a reducing agent. However, the '190 invention requires tempering. The disclosures of U.S. Pat. No. 4,956,190 are hereby incorporated by reference.

Therefore, it would be beneficial and desirable to have a process for reducing or preventing discoloration from pasta made from whole grains, and to produce whole grain pasta products with a pale, amber yellow, or golden color (of traditional pasta), without the necessity of tempering. Tempering of wheat before grinding is a vital step in the milling process in semolina production for pasta manufacture. Tempering consists of adding water to dry grain and allowing the grain to rest for a period of time before it is milled. The purpose of tempering is twofold: 1) to toughen the bran and thus make it resist being broken into small particles during milling and 2) to soften or “mellow” the endosperm and make it easier to grind in to semolina, not into a fine flour. The factors affecting tempering are kernel moisture, time, and temperature.

### SUMMARY OF THE DISCLOSURE

In accordance with the disclosure, there is provided herein a process for improving the color, i.e. preventing brown (bran) color development, of pasta products prepared from whole grains and whole grain flour.

More specifically, there is provided by the present disclosure a process for preparing color-stabilized, whole grain pasta product, wherein the process comprises (a) milling a whole grain source without tempering, (b) adding to the milled grain source a reducing agent, (c) preparing a dough from the mixture, and (d) preparing a pasta product from the dough, wherein the resulting pasta product has a higher pale, amber yellow, or golden color rating than the color rating of a pasta product from the same whole grain in the absence of a reducing agent.

There is also disclosed a whole grain pasta product prepared by the process disclosed herein, wherein the pasta prepared from whole grains has a pale, amber yellow, or golden color. This represents a color rating herein of b≧+15.5 using the Hunter Lab Color Scale. Further, there is also disclosed a method for preventing dark brown color development using a method that employs a reducing agent in the preparation of the pasta derived from whole-grain milled flour in the absence of tempering. The reducing agent can be, for example, sodium metabisulfite, organic acids, SO₂, cysteine, thioglycolic acid, glutathione, or hydrogen sulfide and similar and safe (GRAS) reducing agents. Metabisulfite is a particularly advantageous reducing agent in the present disclosure. Another very useful reducing agent herein is cysteine hydrochloride.

In another embodiment, the whole grain pasta products of the present disclosure contain propylene glycol alginate, (“PGA”) or one or more pharmaceutically acceptable salts thereof. In one embodiment herein, a whole grain pasta product is provided that does not contain eggs (or is essentially free of eggs), which are conventionally required as stabilizers to control pasta product texture. It has been discovered that the presence of PGA or at least one pharmaceutically acceptable salt thereof, at concentrations of from about 1% to about 2% by weight, can eliminate the need for eggs in controlling whole grain pasta texture. In this context, “controlling pasta texture” means maintaining whole grain (wheat) pasta texture at least equal to that of traditional pasta texture made with, semolina, (approximately 60% of wheat kernel-endosperm), as determined or measured by TA-XT2 texture analyzer as well as hedonic scoring of “good”, “very good” or “excellent” by trained sensory panel. Thus, there is provided by the present disclosure a whole grain, color-stabilized pasta, with “good,” “very good,” or “excellent” texture hedonic scoring, that is free of or essentially free of eggs or egg products.

In another embodiment herein is provided a food composition containing carbohydrate source selected from the group consisting of wheat, durum, legumes, tapioca, barley, oat, rice, or corn, or mixture thereof, and propylene glycol alginate or one or more pharmaceutically acceptable salts thereof, wherein the carbohydrate source is whole-grain milled without removal or separation of hull, germ, kernel or other physical edible parts and structures, wherein the food composition is color-stabilized and exhibits a pale, amber yellow, or golden color.

By “pasta” herein is meant macaroni products, noodle products, spaghetti products, vermicelli products and the like, regardless of size, length or shape, or addition or deletion of additives (such as whole eggs or egg whites) or flavorants.

An advantage of one embodiment of the present disclosure is the utilization in a pasta product of milled complete whole wheat, wherein the pasta product has a pale, amber yellow, or golden color, wherein all the components, including the germ, are stabilized and retained in the finished product. This provides nutritional enhancement to the consumer, desirable aesthetic appeal in terms of color rating, and cost reduction to the consumer and increased product yield to the producer. It also meets the FDA guidelines of including at least one serving of ‘WHOLE GRAIN’ in the daily food intake. Conventional procedures often add defatted and/or toasted wheat germ to a milled wheat product which has previously had the germ removed and oxidative enzymes destroyed by toasting. Such supplemental additions are not necessary according to the present invention because the wheat germ is never removed.

It is to be understood that both the foregoing general description and the following detailed description are exemplary and explanatory only and are not restrictive of the disclosure, as claimed.

### DESCRIPTION OF THE EMBODIMENTS

As used herein, the term “whole grain” or “whole grains” is used in its ordinary sense, which is well known to those skilled in the art. Specifically, it refers to flour and pasta products derived from flour made by the milling of a whole grain, said whole grain including, for example, bran, germ, endosperm, kernel, and any combination thereof. Grain sources useful herein for whole milling include but are not limited to wheat, durum wheat, legumes, tapioca, barley, oat, rice, corn, and mixtures thereof. Other benefits of the present disclosure include pasta products containing “higher fiber” and “higher protein” compared to conventional pasta.

By “milling” herein is meant the milling, grinding, bolting, shaping, cutting, crushing, conditioning or particle size reduction of the grain or leguminous material. Milling herein can be accomplished by conventional means, such as a ball mill, a Brabender mill, a two roll mill, a three roll mill, rotary mill, and the like.

In an aspect, there is provided a process for whole grain pasta preparation that does not entail tempering of the grain or flour resulting from the milling of said grain. Rather, the whole grains are milled “dry” with less than about 10% moisture, or in one example only approximately 5% moisture content, in the presence of the reducing agent such as, for example, cysteine hydrochloride or sodium metabisulfite, without tempering. In another embodiment, the moisture content is less than or equal to 28% by weight. The result can be a 100% whole grain pasta product, which is golden yellow in color, yet which retains all the nutritional value of whole grain products. Such a product can also be labeled, packaged and marketed as “whole grain”.

By “reducing agent” herein is meant any compound, chemical, agent, mixture, or substance which is or which produces a material which is, (a) able to chemically reduce and/or reverse the disulfide crosslinking, R—S—S—R, which can result from the oxidative coupling of two sulfhydryl groups, R—SH, on protein(s), (b) able to donate electrons as in a chemical reduction reaction, or (c) otherwise able to produce a whole grain pasta with a color rating of b≧+15.5 using the Hunter Lab Color Scale. The reducing agent useful herein must diminish the discoloration, i.e., stabilize the color, in the resulting pasta product to a color rating of b≧+15.5 using the Hunter Lab Color Scale, as determined dry and before the cooking step using a Hunter Lab Color Meter. By the process of the present disclosure, the color stabilization of the pasta is greatly prolonged over time, compared to the much more rapid color degradation occurring in conventional whole grain pasta. Thus, the whole grain pasta products produced by the present disclosure still exhibit the desirable pale, amber yellow or golden color months after manufacture. In one embodiment the color rating of the whole grain pasta product produced herein is b=+15.6, and in another embodiment the color rating is b=+17.8, as measured by a Hunter Lab Color Scale Meter. In another the color rating is equal to the color rating of conventional non-whole grain pasta. It has been determined according to the present disclosure that the relative dry color rating obtained before cooking the pasta correlates and predicts the color of the cooked pasta, although these can vary slightly.

Particularly effective as reducing agents in the present disclosure are sodium metabisulfite, SO₂ or SO₂-generating precursors, or organic acids such as, for example, cysteine, thioglycolic acid, 1-thioglycerol, thiolactic acid, and similar food grade (GRAS) reducing agents, and mixtures thereof.

Also effective as reducing agents in the present disclosure are the anions of certain inorganic acids such as, for example, sulfurous acid.

The presence of the reducing agent also protects the edible material from chemical or photodegradation (e.g. oxidation) of the natural vitamins and coloring agents, including but not limited to carotenoids (such as beta-carotene), chlorophylls, xanthophylls, and the related lipoxidase-linoleate system. A sulfhydryl or metabisulfite reducing agent may also plasticize or otherwise modify the protein in the outer layers of the grain which produces the flour to thereby facilitate improved flour yields, lower energy consumptions, and increased extrusion rates. The presence of one or more reducing agents in the flour provides a pasta dough extrudable at solids levels higher than pasta dough produced from material prepared in the absence of a reducing agent. This is surprisingly achievable by the viscosity reduction provided to alimentary paste produced by the milling in the presence of a reducing agent.

In one embodiment presented herein, a whole grain pasta product from non-tempered grain(s) is provided which has a color rating of b equal to or greater than +15.6 and which contains PGA or one or more pharmaceutically acceptable salts thereof in an amount of from about 1% to about 2% by weight and which is free of or essentially free of eggs. By “essentially free” of eggs herein is meant the egg white and/or egg yolk content is less than about trace amounts. In one embodiment, the pasta product is completely devoid of whole eggs, egg products, or egg components.

Also provided herein is a food additive concentrate for use in the preparation of a whole grain (untempered) pasta product having a color rating of b equal to or greater than +17.8, said concentrate containing (a) at least one reducing agent selected from the group consisting of sodium metabisulfite, SO₂, SO₂,-generating precursors, cysteine hydrochloride, thioglycolic acid, glutathione, sulfurous acid, and thiolactic acid; and (b) optionally, an amount of PGA or a pharmaceutically acceptable salt thereof. In a utilization of this embodiment, the food additive concentrate or package is provided to a pasta manufacturer who combines the food additive concentrate or package with a milled and non-tempered whole grain source in the preparation of dough for producing pasta with a color rating of b≧+15.5. The food additive concentrate or package can further comprise one or more food additive materials such as but not limited to flavorants, texturizers, diluents, processing aids, vitamins, colorants, herbs, vegetable powder, and minerals.

In one example of this food additive concentrate or package embodiment, the reducing agent is encapsulated or coated to enhance its useful life and improve shipping characteristics to deliver desired reducing and decolorizing performance in the milled whole grain source. The encapsulation of the reducing agent can be achieved by spray drying the reducing agent such as potassium metabisulfite with polydextrins (starch from wheat or corn).

Methods herein for the color stabilization of whole grain pasta can utilize a color code or rating to evaluate the effectiveness of the stabilization. The coloration of the pasta produced herein was evaluated by a color code or color rating using a conventional spectrophotometer following AACC 14-50, a commercially approved method for color rating of pasta. Per U.S.D.A. Commercial Item Description A-A-20062D, the color rating of the product will be ≧3.5 micrograms of pigment per gram of dry pasta.

Additionally, pasta color rating was evaluated using the Hunter Lab Color Scale. The Hunter Lab Color Scale is a visually uniform scale. The Hunter Lab Color Scale is organized in a cube form. The L axis runs from top to bottom. The maximum for L is 100, which would be a perfect reflecting diffuser. The minimum for L would be zero, which would be black. The “a” and “b” axes have no specific numerical limits. Positive “a” is red. Negative “a” is green. Positive “b” is yellow. Negative “b” is blue.

Thus, one object of the present disclosure is to provide a whole wheat pasta product with texture and color similar to, equivalent to, or better than the color and texture of traditional semolina (non-whole grain) pasta products. A whole grain pasta product with a positive b value in the Hunter Lab Color Scale relative to semolina or whole durum pasta is thus provided herein.

Also provided herein is a process for preparing a whole grain pasta product without eggs, said process comprising (a) dry milling, without tempering, a whole grain source in the presence of an effective amount of a reducing agent, (b) combining the milled whole grain source with propylene glycol alginate, or one or more pharmaceutically acceptable salts thereof, and sufficient liquid to produce a dough, and

(c) preparing a pasta product from the dough, wherein the amount of reducing agent is sufficient to produce a color rating in the pasta product of b≧+15.5, and wherein the pasta product is free of, or essentially free of, eggs. The liquid used can be or comprise, for example, water, broth, fats, lipids, other GRAS approved fluids, and mixtures thereof. The PGA or its salt can be present in an amount of from about 1% to 2% by weight.

Since a whole grain pasta product with improved color rating of b≧+15.5 is novel with the present disclosure, a pasta product packaged and/or labeled with “whole grain,” “higher fiber,” and/or “higher protein” advertising or indicia, wherein the pasta product has a color rating of b≧+15.5, is also novel. Therefore, there is provided herein a pasta product packaged with “whole grain”, “high fiber” and/or “higher protein” indicia, wherein the pasta product has a color rating of b≧+15.5.

As provided above, the process of the present disclosure provides for the use of PGA, or one or more pharmaceutically acceptable salts thereof, instead of whole eggs, egg whites and/or egg yolks as a stabilizer to control and provide desired pasta texture in whole grain pasta from untempered grain(s). Thus, there is provided a process for controlling the texture of egg-free pasta, comprising (a) dry milling, without tempering, a whole grain source, (b) combining the milled whole grain source with propylene glycol alginate or at least one pharmaceutically acceptable salts thereof and sufficient liquid to produce a dough which is free of or essentially free of eggs, and (c) preparing a pasta product from the dough made in the presence of an effective amount of a reducing agent, wherein the amount of propylene glycol alginate or salt thereof is sufficient to stabilize the texture and color of the pasta product as determined by an approved texture analyzer (e.g.TA-XT2), Hunter Lab Color Scale score of b≧+15.5 or a hedonic rating of “good,” “very good,” or “excellent” by a trained sensory panel. An effective amount of the reducing agent herein can be, in one embodiment, up to about 700 ppm.

### EXAMPLES

| | Composition | Notes |
|---|---|---|
| Control 1 | 100% semolina | Industry-standard conventional |
| | | pasta formulation (desired |
| | | flavor, texture, and color) |
| Control 2 | 100% whole durum | Current industry-standard whole |
| | | wheat pasta formulation |
| Control 3 | DeCecco whole wheat | Commercially available whole |
| | spagetti | wheat pasta (industry standard |
| | | whole wheat pasta) |
| Test 1 | Whole durum | Invention, one embodiment |
| | 1.25% PGA | |
| | SO2 (500 ppm) | |
| Test 2 | Whole durum | Invention, one embodiment |
| | 1.25% PGA | |

Notes
Commercially-available semolina used in Control 1.
Whole durum flour was milled whole for Control 2. No tempering took place.
Commercially available whole wheat pasta (DeCecco) used for Control 3
Sample Manufacturing Procedure (Control 1, Control 2, Test 1 and Test 2)
Dough was prepared using formulations listed above. Dough moisture ranged from 30% to 36%.
Dough was mixed and formed using a KitchenAid mixer.
Pasta machine (roller) was used to create sheets of dough from setting #1 (thickest) to setting #7 (thinnest).
Strips of fettuccini were cut (w = 0.25″, t = .035″).
Fettuccini was hung on pasta drying rods and dried in a medium temperature dryer (110 F.) for 12 hours.

Samples of the pasta were cooked in boiling water for 9 minutes. A hedonic panel of experienced and certified testers (three in number) evaluated samples of the cooked pasta after allowing the product to come to room temperature (15 minutes). The scores given by each evaluator for appearance (color), flavor, and texture were averaged and reported. Color of the present invention was rated between “good” and “very good;” texture was also rated between “good” and “very good.” Panel members were certified in the Arthur D. Little Flavor Profile Method. These results are presented in Table 1.

TABLE 1
Hedonic ratings of present invention (Test) and Control samples.

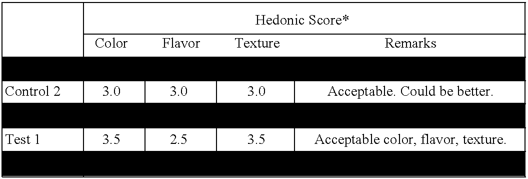

*Hedonic Scoring Scale:
5 = excellent, 4 = very good, 3 = good, 2 = poor, 1 = very poor

Table 2 shows the results of the AACC Method 14-50 calorimetric analysis of the pasta prepared by the present disclosure. A spectrophotometer was utilized to quantify the color differences between the dry samples of Control 1, Control 2, Control 3, Test 1, and Test 2 using the AACC Method 14-50. The yellow pigment content is reported in the Color column. This test showed the present invention (Test 1 and Test 2) to contain more yellow pigment than the Control pastas.

TABLE 2
Spectrophotometer results

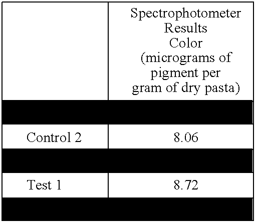

In another color test performed using the Hunter Lab Color Scale procedure described hereinabove, pasta samples were prepared and evaluated as following:

Composition

| | |
|---|---|
| Control 1 | 100% semolina |
| Control 2 | 100% whole durum |
| Control 3 | DeCecco whole wheat spaghetti (commercially available) |
| Test 1 | 100% whole durum, 1.25% PGA, SO₂ (500 ppm) |
| Test 2 | 100% whole durum, 1.25% PGA |

The Hunter Lab Color Scale evaluation results show that the whole grain pasta of the present invention has virtually the same yellow color value as the pasta derived from semolina. These results are presented in Table 3.

TABLE 3
Hunter Lab Color Scale results

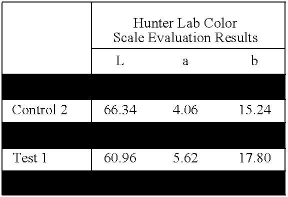

Thus, it can be seen from the table that the color of the whole grain pastas prepared by the present disclosure had significantly more desirable yellow color than the pasta prepared from conventional methods.

Additional objects and advantages of the disclosure will be set forth in part in the description which follows, and/or can be learned by practice of the disclosure. The objects and advantages of the disclosure will be realized and attained by means of the elements and combinations particularly pointed out in the appended claims.

What is claimed is:

1. A process for preparing color stabilized whole grain pasta product, comprising:
(a) milling a whole grain source,
(b) adding to the milled grain source a reducing agent,
(c) preparing a dough from the mixture, and
(d) preparing a pasta product from the dough.

2. The process of claim 1, wherein the whole grain source is selected from the group consisting of wheat, durum wheat, legumes, tapioca, barley, oat, rice, or corn, and mixtures thereof.

3. The process of claim 1, wherein the whole grain source is wheat.

4. The process of claim 1, wherein the milling is dry.

5. The process of claim 4, wherein the milled grain source has a moisture content of less than 28%.

6. The process of claim 4, wherein the milled grain source has a moisture content of less than or equal to 10% by weight.

7. The process of claim 1, wherein the reducing agent is selected from the group consisting of sodium metabisulfite, SO₂, SO₂-generating precursors, cysteine hydrochloride, thioglycolic acid, glutathione, thiolactic acid, sulfurous acid, and thioglycerol.

8. The process of claim 1, wherein the reducing agent comprises sodium metabisulfite.

9. The process of claim 1, wherein the reducing agent is present in an amount sufficient to produce a color rating in the resulting pasta product of b≧+15.5, as determined by the Hunter Lab Color Scale.

10. The process of claim 1, wherein the reducing agent is present in an amount sufficient to produce a positive b color rating on the Hunter Lab Color Scale, relative to the color rating on the Hunter Lab Color Scale for 100% durum wheat pasta not prepared by the process of claim 1.

11. The process of claim 1, further comprising adding to the milled grain source an amount of propylene glycol alginate or at least one pharmaceutically acceptable salt thereof.

12. The process of claim 1, wherein the pasta product is free or essentially free of eggs.

13. A process for preparing a whole grain pasta product having a positive b color rating on the Hunter Lab Color Scale, said process comprising of:
(a) milling a whole grain source,
(b) adding to the milled grain source a reducing agent,
(c) preparing a dough from the mixture, and
(d) preparing a pasta product from the dough, wherein said product has a positive b color rating on the Hunter Lab Color Scale.

14. A process for preparing a whole grain pasta product without eggs, said process comprising (a) dry milling, without tempering, a whole grain source in the presence of an amount of a reducing agent, (b) combining the milled whole grain source with propylene glycol alginate or one or more pharmaceutically acceptable salts thereof and sufficient liquid to produce a dough, and (c) preparing a pasta product from the dough, wherein the amount of reducing agent is sufficient to produce a color rating in the pasta product of b≧+15.5, as determined by the Hunter Lab Color Scale, and wherein the pasta product is free of or essentially free of eggs.

15. A process for controlling the texture of egg-free pasta, said process comprising (a) dry milling, without tempering, a whole grain source in the presence of an amount of a reducing agent, (b) combining the milled whole grain source with propylene glycol alginate or at least one pharmaceutically acceptable salt thereof and sufficient liquid to produce a dough which is free of or essentially free of eggs, and (c) preparing a pasta product from the dough, wherein the amount of propylene glycol alginate or pharmaceutically acceptable salt thereof is sufficient to stabilize the texture of the pasta product as determined by a texture analyzer or trained sensory panel hedonic rating of “good,” “very good,” or “excellent”.

16. A whole grain pasta product having a color rating of a positive b value on the Hunter Lab Color Scale.

17. The whole grain pasta product of claim 16, wherein the product is free of eggs, and further comprises propylene glycol alginate, or at least one pharmaceutically acceptable salt thereof.

18. A process for preparing a whole-grain pasta product having a color rating of b≧+15.5, as determined by the Hunter Lab Color Scale, said process comprising:
(a) milling a whole grain source,
(b) adding to the milled grain source a reducing agent,
(c) preparing a dough from the mixture, and
(d) preparing a pasta product from the dough.

19. A food additive concentrate for use in the preparation of a whole grain pasta product, said concentrate comprising:
(a) at least one reducing agent selected from the group consisting of sodium metabisulfite, SO₂, SO₂,-generating precursors, cysteine hydrochloride, thioglycolic acid, glutathione, thiolactic acid, sulfurous acid, and thio-glycerol, and
(b) optionally, propylene glycol alginate or at least one pharmaceutically acceptable salts thereof.

20. The food additive concentrate of claim 19, wherein the concentrate further comprises one or more materials selected from the group consisting of flavorants, texturizers, diluents, processing aids, vitamins, colorants, herbs, vegetable powder, and minerals.

21. The food additive concentrate of claim 19, wherein the reducing agent is encapsulated or coated.

22. A whole grain pasta product packaged with “whole grain”, “high fiber” and/or “higher protein” indicia, wherein the pasta product has a color rating of b≧+15.5, as determined by the Hunter Lab Color Scale.
